(19) United States
(12) Patent Application Publication
(10) Pub. No.: US 2014/0251482 A1
(43) Pub. Date: Sep. 11, 2014

(54) Fluid Supply Hoses Having a Heat-Shrunk, Antifungal Outer Cover and Method for Making Same

(71) Applicant: DURST CORPORATION, INC., Cranford, NJ (US)

(72) Inventors: Christopher Pike, Princeton, NJ (US); Lawrence B. Brodey, US, NJ (US)

(73) Assignee: DURST CORPORATION, INC., Cranford, NJ (US)

(21) Appl. No.: 13/786,930

(22) Filed: Mar. 6, 2013

(51) Int. Cl. F16L 11/00

(52) U.S. Cl. CPC F16L 11/00
USPC 138/109; 29/428

(57) ABSTRACT

A fluid supply hose includes a hose body having a first end for connection to a fixture and a second end for connection to a water supply. The fluid supply hose includes a tubular cover formed of a heat-shrinkable, antifungal material, which is heat shrunk in place to cover at least a portion of the hose body. The cover could include a decorative exterior. A method of making a fluid supply hose involves inserting a fluid supply hose having a hose body, a first end for connection to a fixture, and a second end for connection to a water supply, into a heat-shrinkable, antifungal tubular cover. The cover is positioned over a portion of the supply hose, and heat is applied to the cover to heat shrink the cover in place to cover at least a portion of the supply hose body. The cover could include a decorative exterior.

### TECHNICAL FIELD

The present disclosure relates to fluid supply hoses. More specifically, the present invention relates to fluid supply hoses having a heat-shrunk, antifungal outer cover, and a method for making same.

### BACKGROUND

Residential and commercial water fixtures often include supply hoses that allow water to be transferred from a building's water piping system to the water fixtures. For example, a residential building generally includes a water piping system that runs through the walls of the building and transfers water to each of the building's rooms where water is desired. The piping system generally extends through at least one of the room's walls and to a water fixture. In a bathroom, this fixture could be a sink, a toilet, a bathtub, a shower, etc. In a kitchen, this fixture could be a sink, a refrigerator water dispenser, an ice maker, etc. In a washroom, this fixture could be a washing machine. In some instances, a pipe can run directly from the building's piping system to the water fixture, but in other instances it is desirable to use a flexible supply hose. In the case of a bathroom's shower, a flexible hose could also be used to connect a shower head to the piping system. The flexible supply hose could be formed from various plastics and polymers, as well as metal connections, such as stainless steel or brass.

A flexible supply hose used to connect the fixture to the piping system could be surround by a braided stainless steel sheath. The braided stainless steel sheath restricts the supply hose from expanding when under pressure and provides a hard protective outer layer for the softer inner hose. Further, this arrangement can extend the life of the supply hose.

The exterior surface of a supply hose can be exposed to organisms, such as fungal spores or bacteria, thereby posing a health risk. Moreover, the exposed surface can corrode over time. Additionally, the braided stainless steel sheath is often unsightly, and can detract from the overall décor of a room.

### SUMMARY OF THE INVENTION

The present invention relates to a fluid supply hose including a hose body having a first end for connection to a fixture and a second end for connection to a water supply. The fluid supply hose includes a tubular cover formed of a heat-shrinkable, antifungal material, which is heat shrunk in place to cover at least a portion of the hose body. The cover could include a decorative exterior.

The present invention still further relates to a method of making a fluid supply hose. A fluid supply hose having a hose body, a first end for connection to a fixture, and a second end for connection to a water supply, is inserted into a heat-shrinkable, antifungal tubular cover. The cover is positioned over a portion of the supply hose, and heat is applied to the cover to heat shrink the cover in place to cover at least a portion of the supply hose body. The cover could include a decorative exterior.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

The foregoing features of the invention will be apparent from the following Detailed Description of the Invention, taken in connection with the accompanying drawings, in which:

FIG. 1 is a perspective view of a conventional fluid supply hose including a braided stainless steel sheath;

FIG. 2 is a perspective view of an antifungal outer cover in accordance with the present disclosure;

FIG. 3 is a perspective view of a fluid supply hose in accordance with the present disclosure;

FIG. 4 is a perspective view of another fluid supply hose in accordance with the present disclosure; and

FIG. 5 is a flow-chart showing steps for making a fluid supply hose in accordance with the present disclosure.

### DETAILED DESCRIPTION OF THE INVENTION

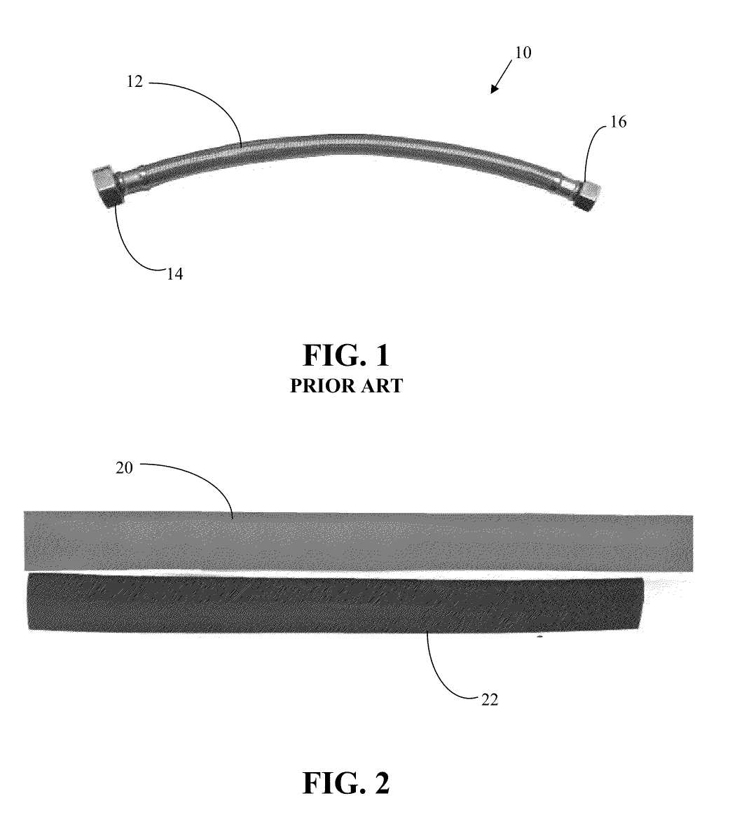

The present disclosure relates to fluid supply hoses having a heat-shrunk, antifungal outer cover, and a method for making same, as discussed in detail below in connection with FIGS. 1-5. As used herein, the terms “antifungal” and “antibacterial” refer to materials that inhibit and/or prohibit growth of undesired organisms, including, but not limited to, fungi, bacteria, molds, spores, and any other undesired organisms that could pose a health threat.

FIG. 1 is a perspective view of a conventional fluid supply hose 10. The supply hose 10 includes an internal hose body (not shown), a braided stainless steel sheath 12, a first connection 14, and a second connection 16. The hose body could be made of polyurethane, polyethylene, PVC, nylon, rubber, polyethylene, polytetrafluoroethylene, or any other material that is known in the art. The first connection 14 and second connection 16 could be constructed of stainless steel, brass, plastic, or any other material that is known in the art. The first connection 14 is generally connected to a building water supply pipe, while the second connection 16 is connected to the fixture, e.g., faucet, washing machine inlet, toilet, ice maker supply, refrigerator water inlet, hand shower inlet, etc. The supply hose 10 places the fixture in fluid communication with the building water supply.

FIG. 2 is a perspective view of an antifungal, heat-shrinkable cover in accordance with the present disclosure. Two covers 20, 22 of different lengths are shown. The covers 20, 22 are formed of heat shrink tubing material that can include a design on the outer surface. The tubular shape, along with the heat shrink tubing material, allows the covers 20, 22 to be placed over a supply hose 10 and secured thereto by heat shrinking. Heat shrinking one of the covers 20, 22 to the supply hose 10 provides a decorative outer surface on the supply hose 10 so that the supply hose 10 blends in with the decor of a room. For example, the first cover 20 could have a lighter color/design that would be suitable for a room having lighter walls, while the second cover 22 could have a darker design more suitable for a room having darker walls. The decorative pattern of the covers 20, 22 is not limited by this example, and could be any solid color, or could be a decorative pattern incorporating various colors, e.g., a checkered pattern, a striped pattern, etc., or could be designed to match the design of a wall or a floor. A user could select a cover having a pattern or color scheme that matches a desired room. The covers 20, 22 could also be made of an anti-fungal and/or anti-bacterial material such as polyvinyl chloride, polyolefin, polyurethane, polyethylene, polypropylene, nylon, fluoropolymer (polytetrafluoroethylene, fluorinated ethylene propylene, perfluoroalkoxy), rubber (thermoplastic rubber/thermoplastic vulcanizates, latex, Viton®, Hytrel®), silicone, braided and expandable sleeving, etc. so that the covers 20, 22 provide a protective layer against fungal and/or bacterial growth on the supply hose 10.

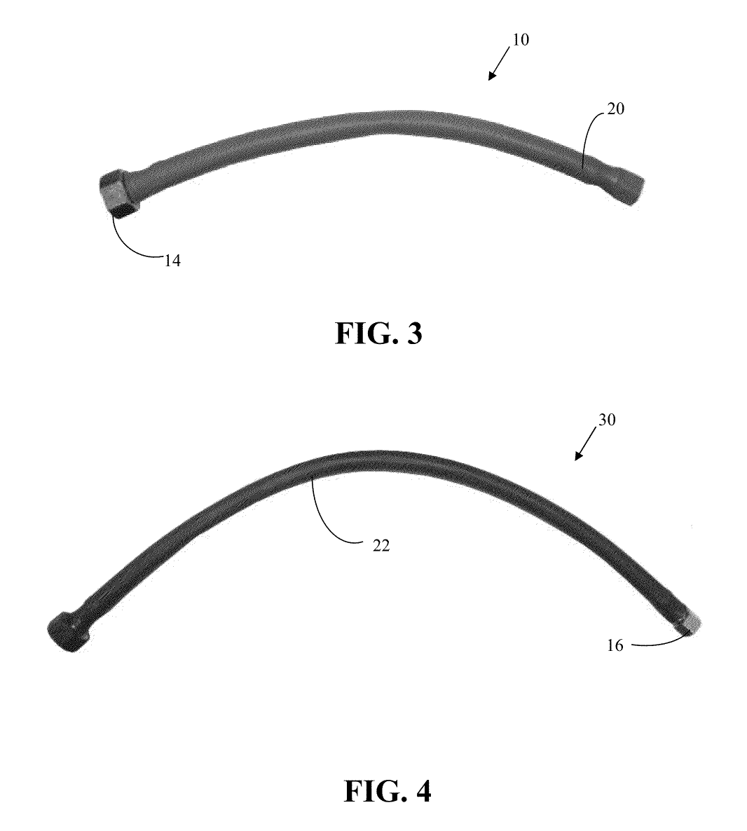

FIGS. 3-4 are perspective views showing the hoses 10, 30 in accordance with the present disclosure, having different lengths. As can be seen, when a cover 20, 22 is placed over a supply hose and heated, it shrinks in size and forms a tight fit around the supply hoses 10, 30, covering nearly the entire lengths of the hoses 10, 30. The covers 20, 22 are not limited to covering just the hose portion, e.g., the braided stainless steel portion, of the supply hose 10, but could also be positioned over the first and second connections 14, 16 so that they are covered as well. For example, in a situation where the first and second connection 14, 16 are made of brass, it could be desirable to protect them from moisture so that they do not corrode. Furthermore, the covers 20, 22 provide a protective layer against destructive elements that could come in contact with the supply hoses 10, 30 and possibly cut, crimp, rip, tear, or otherwise damage the supply hose 10.

When the covers 20, 22 are installed on the supply hose 10, 30, they provide a decorative exterior as well as a protective barrier from moisture, bacteria, and fungus, without restricting the flexibility of the supply hoses 10, 30. One of the benefits of a plastic and braided stainless steel supply hose is that it is flexible. The covers 20, 22 are similarly flexible so as to not significantly restrict the flexibility of the supply hoses 10, 30.

Covers 20, 22 could be provided in a roll of varying lengths, e.g., 5 feet, 10 feet, etc., and can be cut to specific lengths to fit a specific supply hose. This allows the covers 20, 22 to be more versatile. Additionally, this allows a user to mix and match covers 20, 22 or cover portions of the same supply hose 10. A cover 20, 22 can be cut to a length sufficient to cover the braided stainless steel portion of the supply hose 10, and at a later time, smaller pieces can be used to cover just the first or second connection 14, 16.

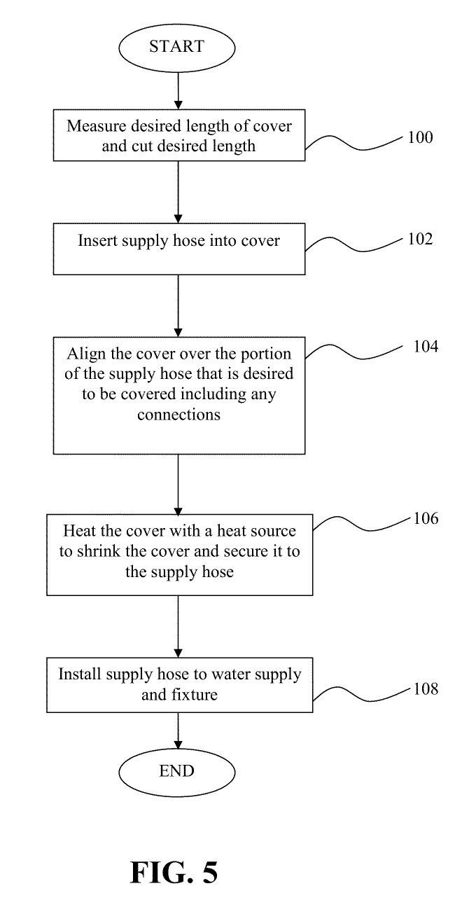

FIG. 5 is a flow-chart showing steps in accordance with the present disclosure for making a fluid supply hose with a heat-shrunk, antifungal outer cover. In step 100, a desired length for the cover 20, 22 is measured, and the cover 20, 22 is cut to the desired length. In step 102, a supply hose 10, 30 is inserted into the previously cut cover 20, 22, such that the cover 20, 22 is placed over the supply hose 20. In step 104, the cover 20, 22 is aligned over the portion of the supply hose 10, 30 that is desired to be covered including any connections 14, 16. In step 106, the cover 20, 22 is heated with an appropriate heat source, e.g., a heat gun, so that it is secured to the supply hose 10, 30. Finally, in step 108, the supply hose 10, 30 including heat-shrunk cover 20, 22 is installed, such that any covered connection is first secured to the water supply and the freely rotatable connection is subsequently secured to the desired fixture.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

What is claimed is:

1. A fluid supply hose, comprising:
a hose body having a first end for connection to a fixture and a second end for connection to a water supply; and
a tubular cover formed of a heat-shrinkable, antifungal material, the tubular cover heat shrunk in place to cover at least a portion of the hose body.

2. The fluid supply hose of claim 1, wherein the cover inhibits or prevents growth of at least one of a fungus, bacteria, mold, or spore.

3. The fluid supply hose of claim 1, wherein the cover includes a decorative exterior.

4. The fluid supply hose of claim 1, wherein the cover is heat-shrunk in place against the hose body and between the first and second connections.

5. The fluid supply hose of claim 1, wherein the cover is heat-shrunk in place against the hose body and at least one of the first and second ends.

6. A method of making a fluid supply hose, comprising:
inserting a fluid supply hose into a heat-shrinkable, antifungal tubular cover, the fluid supply hose having a hose body, a first end for connection to a fixture, and a second end for connection to a water supply;
positioning the cover over a portion of the supply hose; and
applying heat to the cover to heat shrink the cover in place to cover at least a portion of the supply hose body.

7. The method of claim 6, further comprising the step of:
providing the tubular cover as a roll.

8. The method of claim 7, further comprising the step of:
measuring a desired length of tubular cover from the roll of tubular cover.

9. The method of claim 8, further comprising the step of:
cutting the desired length of tubular cover from the roll of tubular cover.

10. The method of claim 6, wherein the cover inhibits or prevents growth of at least one of a fungus, bacteria, mold, or spore.

11. The method of claim 6, wherein the tubular cover includes a decorative exterior.

12. The fluid supply hose of claim 6, wherein the cover is heat-shrunk in place against the hose body and between the first and second connections.

13. The fluid supply hose of claim 6, wherein the cover is heat-shrunk in place against the hose body and at least one of the first and second ends.
